(19) United States
(12) Patent Application Publication
(10) Pub. No.: US 2026/0154122 A1
(43) Pub. Date: Jun. 4, 2026

(54) DYNAMIC REPLICATION COMPUTER RESOURCE SCHEDULING

(71) Applicant: SAP SE, Walldorf (DE)

(72) Inventors: Daniel BOS, Beijing (CN); Peter SCHOENAU, Untergruppenbach (DE); Tobias KARPSTEIN, Eschelbronn (DE)

(21) Appl. No.: 18/966,910

(22) Filed: Dec. 3, 2024

(51) Int. Cl. G06F 9/50

(52) U.S. Cl. CPC G06F 9/5038; G06F 9/5072

(57) ABSTRACT

A scheduling framework may include a change rate data store that contains information about replication change rates for a source system over time. A computing resources scheduling server may access change rate information from the change rate data store representing data replication from the source system to a target system. The scheduling server may automatically calculate a computing resource value (e.g., a number of replication-worker instances) based on a Gaussian ceiling function and the change rate information. The scheduling server can then dynamically adjust at least one replication computing resource allocation in accordance with the calculated computing resource value. The system may arrange for the allocated computing resource to facilitate data replication from the source system to the target system. The dynamic adjustment of the replication computing resource allocation might also be based on a start-up time, a boundary, prior change rates, a PID controller, etc.

### BACKGROUND

Replicating data from one system to another (e.g., copying data from a source location to a target location) can be a slow and time-consuming process, particularly if there is a substantial amount of data to be replicated. For example, FIG. 1 is a traditional data replication system 100 that may be used to replicate data from a source 110 to a target 120. Readers 112 at the source 110 access the data from local storage 114 in accordance with Change Data Capture (“CDC”) 116 information (e.g., to avoid replication of unchanged data). Workers 132 at replication middle ware 130 can then transfer that data from the readers 112 to writers 122 at the target 120. An administrator 134 and/or orchestrator 134 may facilitate this transfer. Finally, the writers 122 save the replicated data into local storage 124 at the target 120, completing the process.

Note that computing resources (e.g., processing, memory, network, storage, etc.) are required to move the data. The more data that needs to be replicated, the more resources will be required. Moreover, resources are required by all of the involved systems 110, 120, 130. In particular, the source 110 may require resources in order: to keep track of the changes that are happening; to read the CDC 116 information as well as the data being replicated from storage 114; and, after successfully writing the data, updating the CDC 116 to reflect that processing was successful. The replication middleware 130 may require resources: to support an administrator 140 interface (including monitoring, statistics, etc.); to have a central orchestrator to schedule the actual replication workers 132; to run the active replication workers 132; and to keep track of the overall replication processing. The target 120 may require resources to write or delete data in storage 124.

Note that some or all of the replication middleware 130 component can, in many cases, also be run in the source 110 or the target 120. However, this does not change the overall system 100 resource requirements (because the resource requirements of the replication middleware component 130 would now need to be covered by the source 110 and/or the target 120.

This type of solution typically scales by scheduling more replication workers 132 and therefore utilizing more connections and readers 112 in the source 110 as well as more connections and writers 122 in the target 120. Typically, there is a one-to-one cardinally (meaning that one replication worker 132 instance works with one reader 112 as well as one writer 122).

It is desirable to provide dynamic replication computer resource scheduling in a secure, automatic, and efficient manner.

### SUMMARY

According to some embodiments, methods and systems associated with a scheduling framework may include a change rate data store that contains information about replication change rates for a source system over time. A computing resources scheduling server may access change rate information from the change rate data store representing data replication from the source system to a target system. The scheduling server may automatically calculate a computing resource value (e.g., a number of replication-worker instances) based on a Gaussian ceiling function and the change rate information. The scheduling server can then dynamically adjust at least one replication computing resource allocation in accordance with the calculated computing resource value. The system may arrange for the allocated computing resource to facilitate data replication from the source system to the target system. The dynamic adjustment of the replication computing resource allocation might also be based on a start-up time, a boundary, prior change rates, a PID controller, etc.

Some embodiments comprise: means for accessing, by a computer processor of a computing resources scheduling server, change rate information that represents data replication from a source system to a target system from a change rate data store that contains information about replication change rates for the source system over time; means for automatically calculating a computing resource value based on a Gaussian ceiling function and the change rate information; means for dynamically adjusting at least one replication computing resource allocation in accordance with the calculated computing resource value; and means for arranging for the allocated computing resource to facilitate data replication from the source system to the target system.

Some technical advantages of some embodiments disclosed herein are improved systems and methods to provide dynamic replication computer resource scheduling in a secure, automatic, and efficient manner.

### BRIEF DESCRIPTION OF THE DRAWINGS

FIG. 1 is a traditional data replication system.

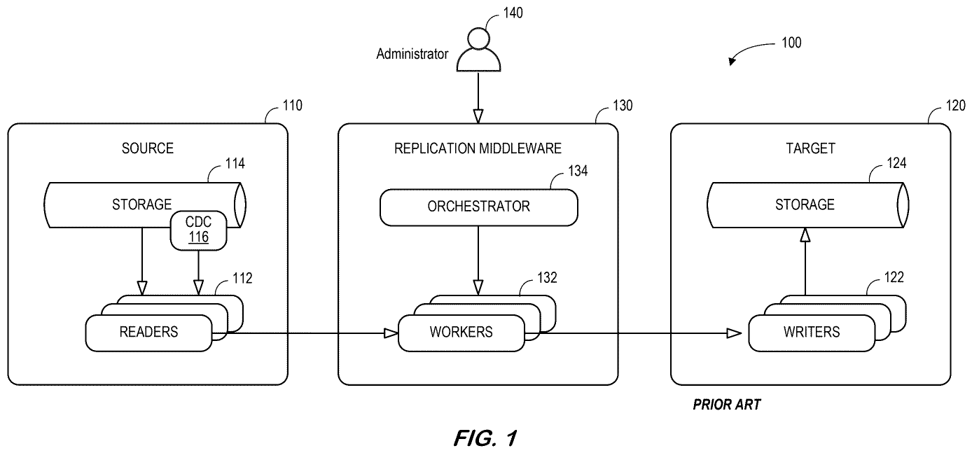

FIG. 2 shows data change rates over time.

FIG. 3 is a data replication system architecture in accordance with some embodiments.

FIG. 4 is a data replication method according to some embodiments.

FIG. 5 is a more detailed data replication system according to some embodiments.

FIG. 6 is a more detailed data replication system in accordance with some embodiments.

FIG. 7A is a more detailed data replication process in accordance with some embodiments.

FIGS. 7B through 7D illustrate PID damping.

FIG. 8 is an apparatus or platform according to some embodiments.

FIG. 9 is a portion of a data replication database in accordance with some embodiments.

FIG. 10 illustrates a tablet computer data replication system display according to some embodiments.

FIG. 11 is a data replication system operator or administrator display in accordance with some embodiments.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

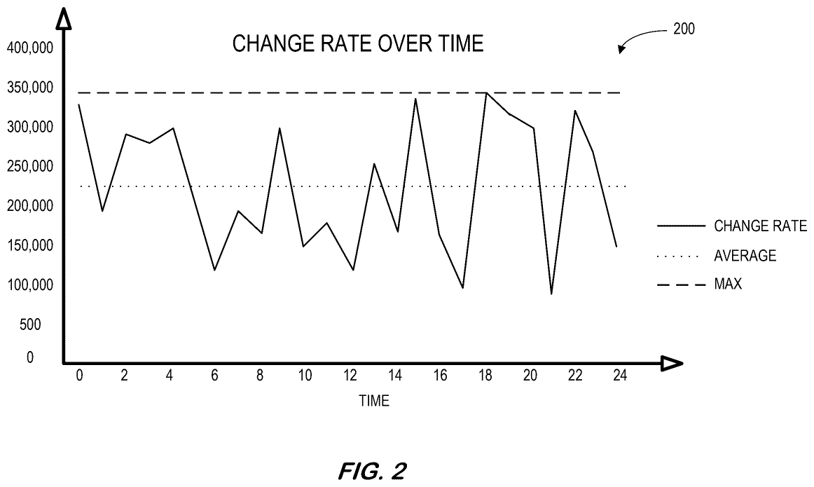

A significant challenge in replication scenarios is selecting and allocating an appropriate amount of computing resources, such as how many replication worker instances are required to cope with a change rate and replicate all changes from a source to a target system. Typically, the change rate is not static but fluctuates over time with partially extreme peak values (e.g., at month end, quarter end closing, or batch operations). FIG. 2 is a graph 200 that shows data change rates over time for a high-level replication set-up from a source system into a target system via middleware (shown as a solid line in FIG. 2). It may be difficult or impossible to find a static amount of replication worker instances which provide adequate data latency while not having idle replication worker instances.

One approach is to allocate resources based on the peak change rate (shown as a dashed line in FIG. 2). Since the amount of replication workers can keep up with peak change rates, the system can guarantee a low replication latency at all times. The disadvantage with this approach is that during non-peak times the replication workers are not fully utilized resulting in an unnecessarily high Total Cost of Ownership (“TCO”). Based on the graph 200, the replication worker instances would need to keep up with a change rate of approximately 350,000.

Another approach is to allocate resources based on the average change rate (shown as a dotted line in FIG. 2). If the amount of replication workers is determined based on the average change rate of the source, the system can minimize the cost and/or TCO. The disadvantage with this approach is that during peak intervals the latency can drastically increase which can create severe downstream problems. From a TCO perspective, there might still be times with a low change rate in which replication workers would be idle. Based on the graph 200, the replication worker instances would need to keep up with a change rate of approximately 220,000.

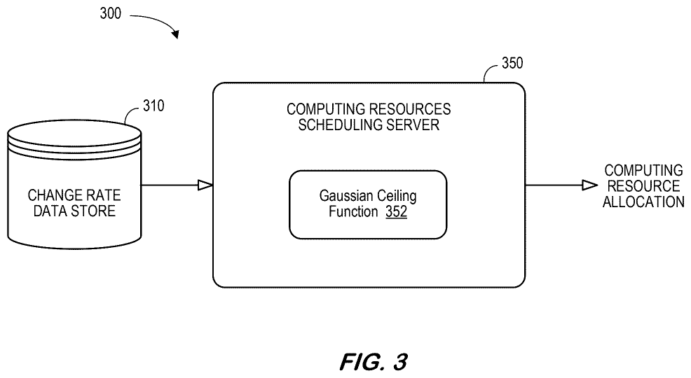

To address these issues, FIG. 3 is a high-level block diagram of one example of a dynamic replication computer resource scheduling system 300 architecture according to some embodiments. In particular, a computing resources scheduling server 350 may access information in a change rate data store 310 and use a Gaussian ceiling function 352 to determine an appropriate computing resource allocation.

As used herein, devices, including those associated with the system 300 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The computing resources scheduling server 350 may store information into and/or retrieve information from various data stores (e.g., the change rate data store 310), which may be locally stored or reside remote from the computing resources scheduling server 350. Although a single computing resources scheduling server 350 is shown in FIG. 3, any number of such devices may be included. Moreover, various devices described herein might be combined according to embodiments of the present invention. For example, in some embodiments, the change rate data store 310 and the computing resources scheduling server 350 might comprise a single apparatus. The system 300 functions may be performed by a constellation of networked apparatuses, such as in a distributed processing or cloud-based architecture. In some cases, the computing resources scheduling server 350 may process information associated with a number of different tenants or enterprises.

An enterprise may access the system 300 via a remote device (e.g., a Personal Computer (“PC”), tablet, or smartphone) to view information about and/or manage operational information in accordance with any of the embodiments described herein. In some cases, an interactive Graphical User Interface (“GUI”) display may let an operator or administrator define and/or adjust certain parameters via a remote device (e.g., to specify maximum or minimum boundaries for a computing environment infrastructure) and/or provide or receive automatically generated recommendations, alerts, summaries, or results associated with the system 300.

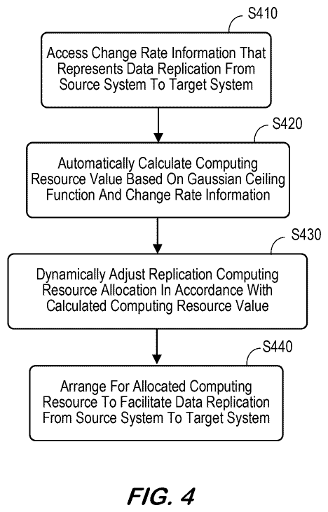

FIG. 4 is a method that might be performed by some or all of the elements of the system 300 described with respect to FIG. 3. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S410, change rate information that represents data replication from a source system to a target system is accessed. At S420, a computing resources scheduling server automatically calculates a computing resource value based on a Gaussian ceiling function and the change rate information. The computing resource might be associated with, for example, a number of replication-worker instances. Other examples of computing resources include a Central Processing Unit (“CPU”) resource, a memory resource, a network resource, a storage resource, etc. According to some embodiments, the computing resource is associated with replication middleware. For example, the replication middleware might be executed by a replication middleware component, the source system, the target system, etc. The Gaussian ceiling function might comprise, for example:

$$f ( x ) = ⌈ \frac{x}{n} ⌉$$

where x is the change rate of the source system and n is an amount of change rate supported by a unit of computing resources.

At S430, at least one replication computing resource allocation is dynamically adjusted in accordance with the calculated computing resource value. At S440, it is arranged for the allocated computing resource to facilitate data replication from the source system to the target system.

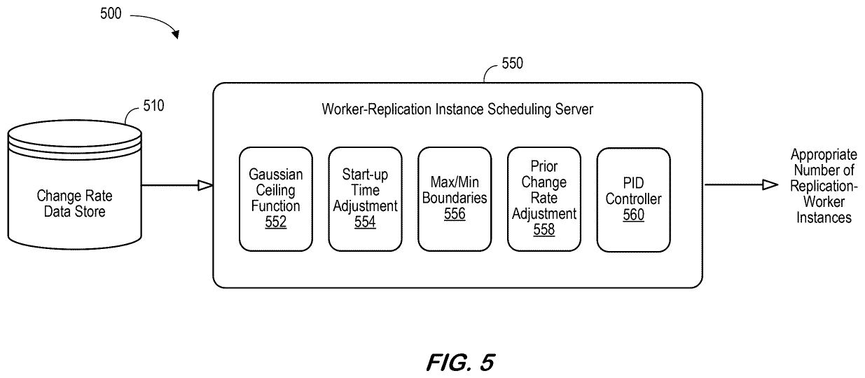

FIG. 5 is a more detailed data replication system 500 according to some embodiments. As before, a worker-replication scheduling server 550 may access information in a change rate data store 510 and use a Gaussian ceiling function 552 to determine an appropriate number of worker-replication instances to support the change rate. In this case, the dynamic adjustment of the replication computing resource allocation is further adjusted based on: a start-up time 554; a minimum boundary or a maximum boundary 556; prior change rates 558; and/or a Proportional Integral Derivative (“PID”) controller 560 (e.g., to reduce oscillation).

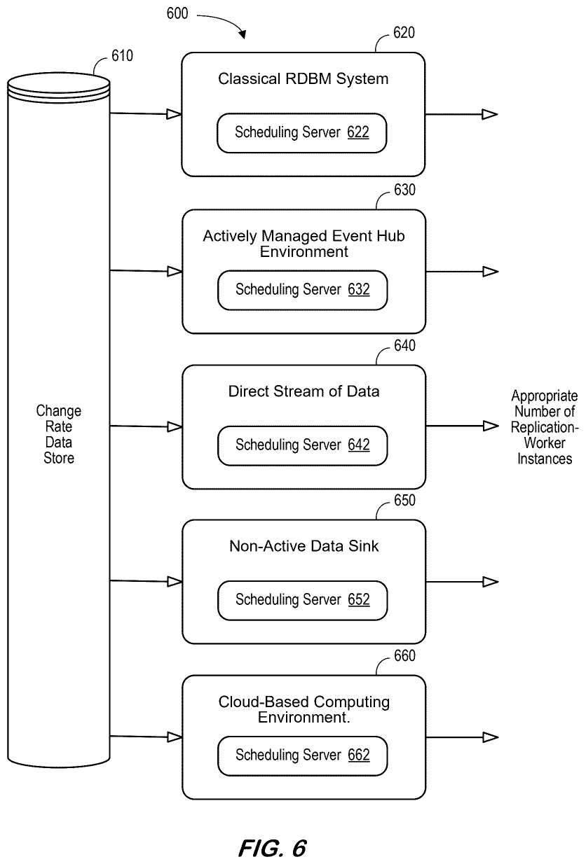

Note that in different source environments (making use of different technology stacks with different qualities) the detection and accuracy of the change rate might differ quite a lot and must be accounted for when adding or removing replication worker instances. FIG. 6 is a more detailed data replication system 600 in accordance with some embodiments. In this example, a scheduling server 622 in a classical Relational Database Management (“RDBM”) system 620 may determine an appropriate number of replication-worker instances based on information from a change data rate store 610. In classical database systems, the server 622 can either look at statistics provided by the database itself or the change-data-capture mechanism itself may provide the means to identify the change rate. This is, for example, the case for a trigger-based CDC mechanism, where each individual change (e.g., an INSERT, UPDATE, UPSERT or DELETE) will be recorded by a respective trigger. Besides identifying what changed, the information can also be used to track how many changes occurred in a certain time interval. This information might be retrieved by an orchestrator to allocate accordingly.

A scheduling server 632 in an actively managed event hub environment 630 may also determine an appropriate number of replication-worker instances. An actively managed hub environment 630 might refer to any kind of system that actively manages input streams and provides access to consumers via output streams (e.g., APACHE® Kafka). Such actively managed environments often have means to retrieve the backlog which has not yet been processed by a certain consumer. If the backlog is growing or shrinking, this information can also be used to adjust the amount of replication worker instances.

A scheduling server 642 in a direct stream of data environment 640 may also determine an appropriate number of replication-worker instances. In scenarios where data is directly streamed into the replication workers (e.g., sensor data), the utilization of the instances can be monitored and used as an indicator of changes to the change rate. A scheduling server 652 in a non-active data sink environment 650 may also determine an appropriate number of replication-worker instances. In scenarios with minimal to no orchestration layer and data is unloaded to as a sink (e.g., plain object stores), it may be substantially harder to have high quality information about aspects such as the change rate. In general, however, embodiments may support a replication scheduling server 662 that is able to allocate resources for any cloud-based computing environment 660.

In this way, embodiments may dynamically adjust used resources based on detecting fluctuations in the change rate of the source system. As a result, an appropriate resource utilization can be achieved by increasing (or decreasing) the resources used for the data replication. Moreover, certain maximum or minimum values could be provided by an administrator to keep the resource usage within certain boundary conditions.

Embodiments may use information about a source system change rate to dynamically adjust the replication worker instances. If a decrease in the change rate below a certain threshold is detected, at least one replication worker instance can be switched off. If an increase in the change rate above a certain threshold is detected, at least one additional replication worker instance may be scheduled. In this way, an appropriate amount of replication worker instances may be active at any given point in time.

An appropriate amount of required replication worker instances can be calculated with the help of a Gaussian ceiling function:

$$f ( x ) = ⌈ \frac{x}{n} ⌉$$

where x is the change rate of the source system and n is an amount of change rate supported by a single replication-worker instance.

For example, if one replication worker instance can keep up with 50,000 changes per second and in the system the current change rate is at 333,000 changes per second, the formula provides:

$$f ( x ) = ⌈ \frac{330 , 000}{50 , 000} ⌉$$

$$f ( x ) = ⌈ 6.66 ⌉$$

$$f ( x ) = 7$$

This means that seven replication worker instances may be allocated to keep up with the change rate.

If at a later point in time (e.g., during a more intense calculation run) the change rate increases to 487,000 changes per second, the formula provides:

$$f ( x ) = ⌈ \frac{487 , 000}{50 , 000} ⌉$$

$$f ( x ) = ⌈ 9.74 ⌉$$

$$f ( x ) = 10$$

This means that the orchestrator should schedule three additional replication worker instances.

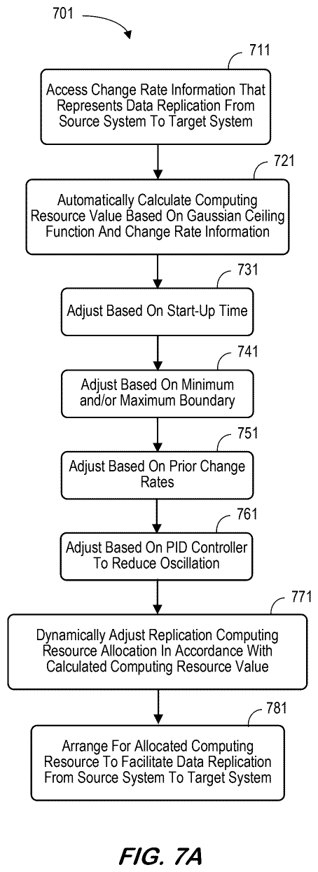

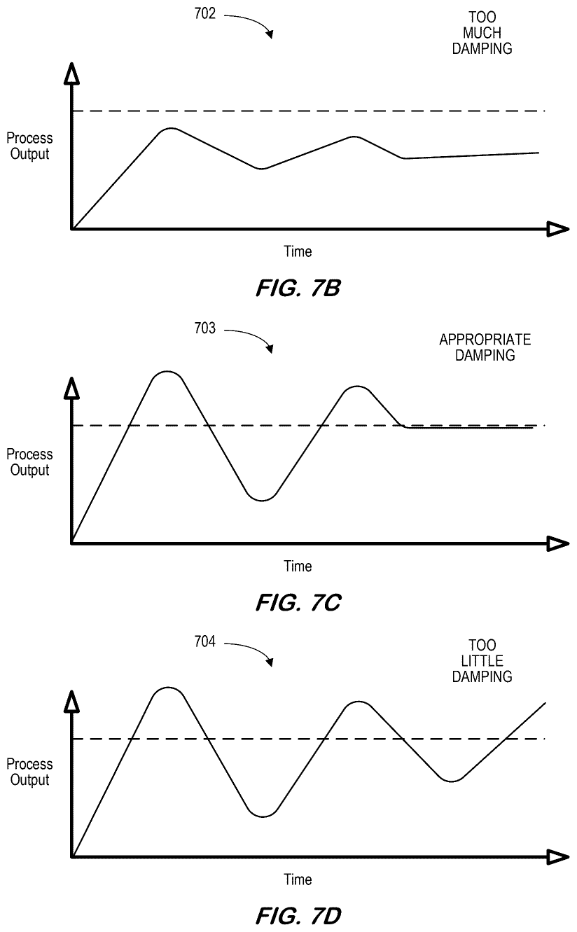

FIG. 7A is a more detailed data replication process 701 in accordance with some embodiments. At 711, change rate information that represents data replication from a source system to a target system is accessed. At 721, a computing resources scheduling server automatically calculates a computing resource value based on a Gaussian ceiling function and the change rate information. The computing resource might be associated with, for example, a number of replication-worker instances, a CPU resource, a memory resource, a network resource, a storage resource, etc. According to some embodiments, the computing resource is associated with replication middleware (e.g., executed by a replication middleware component, the source system, the target system, etc.).

At 731, the dynamic adjustment of the replication computing resource allocation is further based on a start-up time. For example, scheduling logic in the orchestrator could also account for certain start-up times for additional replication worker instances or measuring inaccuracies (e.g., by starting the next instance at 80% of the value of the ceiling function).

At 741, the dynamic adjustment of the replication computing resource allocation is further based on a minimum boundary or a maximum boundary. Independent of the possible maximum change rate in the source system there might be a request to limit the maximum number of replication worker instances for TCO or other reasons. Such boundary conditions for maximum (or minimum) active replication worker instances could be handled like the start-up adjustments or could be handled via configuration settings maintained by a system administrator influencing the behavior of the orchestrator.

At 751, the dynamic adjustment of the replication computing resource allocation is further based on prior change rates. In addition to the configuration settings, information about past periodic changes or patterns in the change rate may be used to pro-actively schedule additional (or fewer) replication worker instances. Examples of such detectable periodic changes might include month end or quarter end closing runs, weekends, holidays, etc. To predictively make scheduling decisions upfront based on historic data may require not just keeping track of the current change rate in the system but also persisting the change rate over a longer period of time. In the year-end closing example, several years of such statistical data might be required. To reduce the amount of this type of statistical data, the system may aggregate information to a level where it is still usable without requiring too much storage.

At 761, the dynamic adjustment of the replication computing resource allocation is further based on a PID controller to reduce oscillation. To avoid oscillations due to short bursts or dips to the change rate, logic from process automation, such as PID-controllers, can be used to provide feedback loops that prevent unnecessary loads to the system. A simple example may be similar to a thermostat. If it switches on, it will take an amount of time for the temperature to increase. Conversely, when it switches off, it will take an amount of time for the temperature to decrease. If the system made decisions based on the instantaneous value, it would end up with oscillation because the temperature will overshoot in both directions. PID-controllers let the system mix derivatives and integrals together with the instantaneous value to (1) prevent the oscillation and (2) predict the future value (e.g., the system may switch off while still one below the target, knowing that it will overshoot one degree (and end up at the set value eventually).

Note that the amount of damping in a PID controller will impact the oscillation of the output. For example, FIG. 7B is a graph 702 that illustrates too much dampening. The system may never actually reach the desired resource allocation (represented by a dashed line in the graph 702). Similarly, the system could also end up with a too high allocation resource allocation. FIG. 7C is a graph 703 that illustrates an appropriate setting that results in minimal oscillation quickly ends up at the desired resource allocation. Finally, FIG. 7D is a graph 704 that illustrates too little dampening. In this case, system may keep overshooting with too much or too few allocated resources.

Referring again to FIG. 7A, at 771 at least one replication computing resource allocation is dynamically adjusted in accordance with the calculated computing resource value. At 781, it is arranged for the allocated computing resource to facilitate data replication from the source system to the target system.

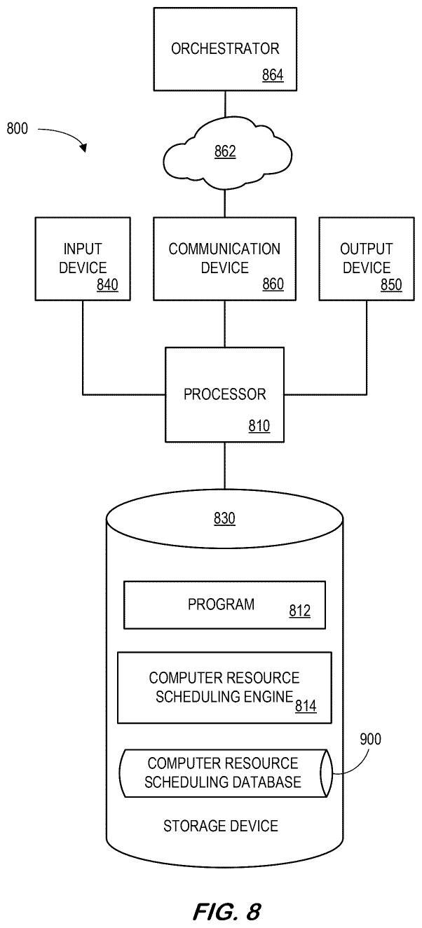

Note that the embodiments described herein may be implemented using any number of different hardware configurations. For example, FIG. 8 is a block diagram of an apparatus or platform 800 that may be, for example, associated with the system 300 of FIG. 3 (and/or any other system described herein). The platform 800 comprises a processor 810, such as one or more commercially available Central Processing Units (“CPUs”) in the form of one-chip microprocessors, coupled to a communication device 860 configured to communicate via a communication network 862. The communication device 860 may be used to communicate, for example, with one or more orchestrators 864 via a distributed computer network 862. The platform 800 further includes an input device 840 (e.g., a computer mouse and/or keyboard to input boundary values, data mappings, cloud configurations, etc.) and an output device 850 (e.g., a computer monitor to render a display, transmit recommendations, charts, alerts, and/or reports about a replication scheduling framework or service, etc.).

The processor 810 also communicates with a storage device 830. The storage device 830 may comprise any appropriate information storage device, including combinations of magnetic storage devices (e.g., a hard disk drive), optical storage devices, mobile telephones, and/or semiconductor memory devices. The storage device 830 stores a program 812 and/or a computer resource scheduling engine 814 for controlling the processor 810. The processor 810 performs instructions of the programs 812, 814, and thereby operates in accordance with any of the embodiments described herein. For example, the processor 810 may access change rate information from a change rate data store representing data replication from the source system to a target system. The processor 810 may automatically calculate a computing resource value (e.g., a number of replication-worker instances) based on a Gaussian ceiling function and the change rate information. The processor 810 can then dynamically adjust at least one replication computing resource allocation in accordance with the calculated computing resource value. The processor 810 may arrange for the allocated computing resource to facilitate data replication from the source system to the target system. The dynamic adjustment of the replication computing resource allocation might also be based on a start-up time, a boundary, prior change rates, a PID controller, etc.

The programs 812, 814 may be stored in a compressed, uncompiled and/or encrypted format. The programs 812, 814 may furthermore include other program elements, such as an operating system, clipboard application, a database management system, and/or device drivers used by the processor 810 to interface with peripheral devices.

As used herein, information may be “received” by or “transmitted” to, for example: (i) the platform 800 from another device; or (ii) a software application or module within the platform 800 from another software application, module, or any other source.

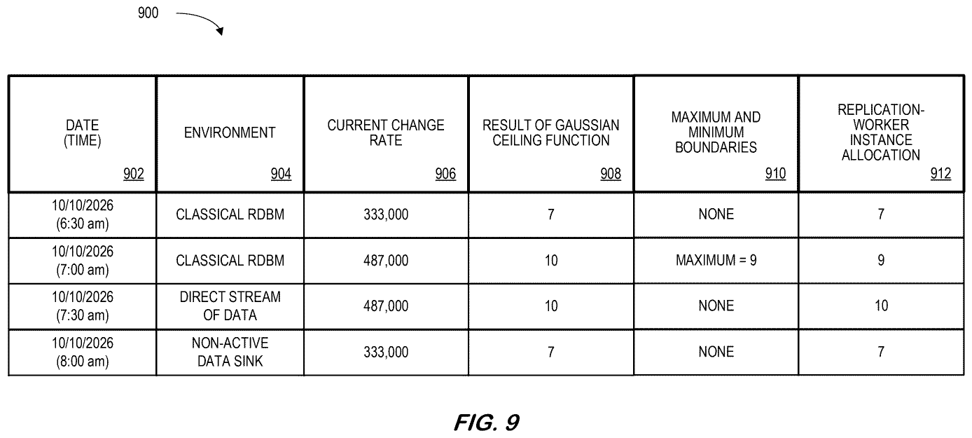

In some embodiments (such as the one shown in FIG. 8), the storage device 830 further stores a computer resource scheduling database 900. An example of a database that may be used in connection with the platform 800 will now be described in detail with respect to FIG. 9. Note that the database described herein is only one example, and additional and/or different information may be stored therein. Moreover, various databases might be split or combined in accordance with any of the embodiments described herein.

Referring to FIG. 9, a table is shown that represents the computer resource scheduling database 900 that may be stored at the platform 800 according to some embodiments. The table may include, for example, entries identifying periodic resource allocations for data replication. The table may also define fields 902, 904, 906, 908, 910, 912 for each of the entries. The fields 902, 904, 906, 908, 910, 912 may, according to some embodiments, specify: a date and time 902, an environment 904, a current change rate 906, a result of a Gaussian ceiling function 908, maximum and minimum boundaries 910, and a replication-worker instance allocation 912. The computer resource scheduling database 900 may be created and updated, for example, when a new allocation is calculated, various boundary parameters are altered, etc.

The date and time 902 may indicate when the allocation was adjusted. The environment 904 might indicate a type of operating environment (e.g., classical RDBM, hub, direct stream of data, etc.). The current change rate 906 may indicate how frequently the source data is changing. The result of a Gaussian ceiling function 908 may be calculated in accordance with any of the embodiments described herein. The maximum and minimum boundaries 910 might represent limits imposed by an administrator. The replication-worker instance allocation 912 might indicate an appropriate amount of computing resources that should be allocated to support data replication.

Thus, embodiments may dynamically adjust allocated resources by detecting fluctuations in the change rate of the source system. Embodiments may calculate an appropriate resource utilization and increase or decrease the amount resources that allocated for data replication. This may improve the performance of the system and/or reduce costs.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with some embodiments of the present invention (e.g., some of the information associated with the databases described herein may be combined or stored in external systems). Moreover, although some embodiments are focused on particular types of replication environments and allocation adjustments, any of the embodiments described herein could be applied to other types of replication environments and allocation adjustments. Moreover, depending on available options, a system might count a number of files being replicated and combine this with metadata about the size of those files to adjust amounts of replication allocations as appropriate.

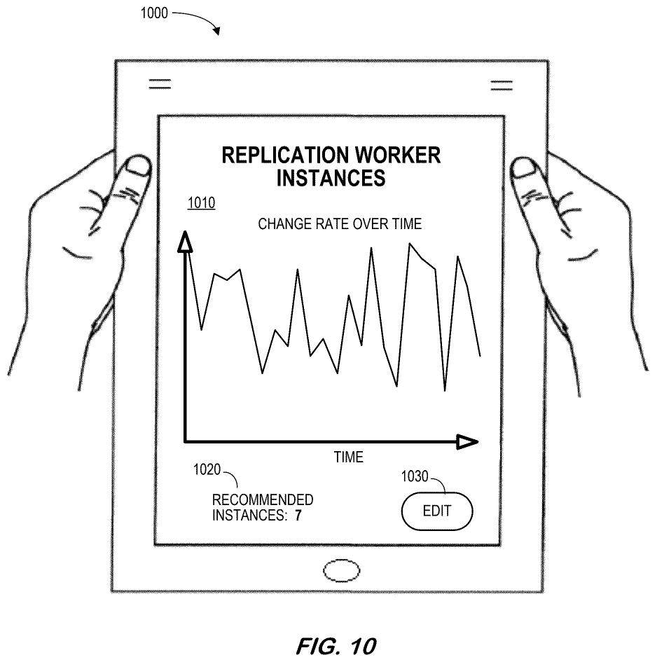

In addition, the displays shown herein are provided only as examples, and any other type of user interface could be implemented. For example, FIG. 10 illustrates a tablet computer 1000 providing a dynamic replication computer resource scheduling display 1010 according to some embodiments. The display 1010 might be used, for example, to troubleshoot replication-worker instance allocations 1020. A user may interact with the display 1010, such as by touching an element of the display 1010 and selecting an “Edit” icon 1030. In this way, the user may see more information about an element of the configuration setup.

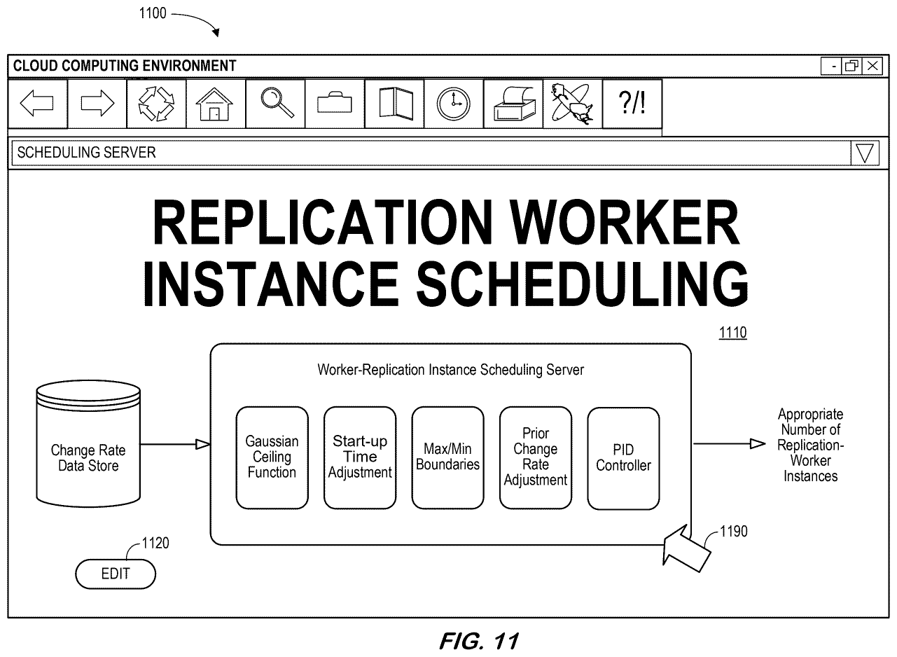

FIG. 11 is an operator or administrator display 1100 in accordance with some embodiments. The display 1100 includes a graphical representation 1110 of a dynamic replication computer resource scheduling system in accordance with any of the embodiments described herein. Selection of an element on the display 1100 (e.g., via a touchscreen or computer pointer 1190) may result in display of a pop-up window containing more detailed information about that element and/or various options (e.g., to define boundary conditions, adjust replication parameters, etc.). Selection of an “Edit” icon 1120 may also let an operator or administrator adjust the operation of the system (e.g., to change mappings to a data store, adjust cloud implementation properties, etc.).

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

1. A system associated with a scheduling framework, comprising:
a change rate data store containing information about replication change rates for a source system over time; and
a computing resources scheduling server, coupled to the change rate data store, including:
a computer processor, and
a computer memory storing instructions that, when executed by the computer processor, cause the computing resources scheduling server to:
access change rate information from the change rate data store representing data replication from the source system to a target system,
automatically calculate a computing resource value based on a Gaussian ceiling function and the change rate information,
dynamically adjust at least one replication computing resource allocation in accordance with the calculated computing resource value, and
arrange for the allocated computing resource to facilitate data replication from the source system to the target system.

2. The system of claim 1, wherein the computing resource is associated with a number of replication-worker instances.

3. The system of claim 2, wherein the computing resources further includes at least one of: (i) a Central Processing Unit (“CPU”) resource, (ii) a memory resource, (iii) a network resource, and (iv) a storage resource.

4. The system of claim 1, wherein the computing resource is associated with replication middleware.

5. The system of claim 4, wherein the replication middleware is executed by at least one of: (i) a replication middleware component, (ii) the source system, and (iii) the target system.

6. The system of claim 1, wherein the Gaussian ceiling function comprises:
$$f ( x ) = ⌈ x / n ⌉$$
where x is the change rate of the source system and n is an amount of change rate supported by a unit of computing resources.

7. The system of claim 1, wherein the dynamic adjustment of the replication computing resource allocation is further based on a start-up time.

8. The system of claim 1, wherein the dynamic adjustment of the replication computing resource allocation is further based on a minimum boundary or a maximum boundary.

9. The system of claim 1, wherein the dynamic adjustment of the replication computing resource allocation is further based on prior change rates.

10. The system of claim 1, wherein the dynamic adjustment of the replication computing resource allocation is further based on a Proportional Integral Derivative (“PID”) controller to reduce oscillation.

11. The system of claim 1, wherein the scheduling framework is associated with at least one of: (i) a classical Relational Database Management (“RDBM”) system, (ii) an actively managed event hub environment, (iii) a direct stream of data, (iv) a non-active data sink, and (v) a cloud-based computing environment.

12. A computer-implemented method associated with a scheduling framework, comprising:
accessing, by a computer processor of a computing resources scheduling server, change rate information that represents data replication from a source system to a target system from a change rate data store that contains information about replication change rates for the source system over time;
automatically calculating a number of replication-worker instances based on a Gaussian ceiling function and the change rate information;
dynamically adjusting a replication-worker instance allocation in accordance with the calculated number; and
arranging for the allocated number of replication-worker instances to facilitate data replication from the source system to the target system.

13. The method of claim 12, wherein the replication-worker instances are associated with replication middleware executed by at least one of: (i) a replication middleware component, (ii) the source system, and (iii) the target system.

14. The method of claim 12, wherein the Gaussian ceiling function comprises:
$$f ( x ) = ⌈ x / n ⌉$$
where x is the change rate of the source system and n is an amount of change rate supported by a one replication-worker instance.

15. One or more non-transitory computer-readable media storing computer-executable instructions that, when executed by a computing system, cause the computing system to perform operations for a scheduling framework, comprising:
accessing, by a computer processor of a computing resources scheduling server, change rate information that represents data replication from a source system to a target system from a change rate data store that contains information about replication change rates for the source system over time;
automatically calculating a computing resource value based on a Gaussian ceiling function and the change rate information;
dynamically adjusting at least one replication computing resource allocation in accordance with the calculated computing resource value; and
arranging for the allocated computing resource to facilitate data replication from the source system to the target system.

16. The media of claim 15, wherein the computing resource is associated with at least one of: (i) a number of replication-worker instances, (ii) a Central Processing Unit (“CPU”) resource, (iii) a memory resource, (iv) a network resource, and (v) a storage resource.

17. The media of claim 15, wherein the dynamic adjustment of the replication computing resource allocation is further based on a start-up time.

18. The media of claim 15, wherein the dynamic adjustment of the replication computing resource allocation is further based on a minimum boundary or a maximum boundary.

19. The media of claim 15, wherein the dynamic adjustment of the replication computing resource allocation is further based on prior change rates.

20. The media of claim 15, wherein the dynamic adjustment of the replication computing resource allocation is further based on a Proportional Integral Derivative (“PID”) controller to reduce oscillation.

21. The media of claim 15, wherein the scheduling framework is associated with at least one of: (i) a classical Relational Database Management (“RDBM”) system, (ii) an actively managed event hub environment, (iii) a direct stream of data, (iv) a non-active data sink, and (v) a cloud-based computing environment.
